(19) United States
(12) Patent Application Publication
(10) Pub. No.: US 2013/0106235 A1
(43) Pub. Date: May 2, 2013

(54) DISK MOTOR AND ELECTRIC POWER TOOL EQUIPPED WITH THE SAME

(71) Applicants: Kenichirou YOSHIDA, Hitachinaka (JP); Hideyuki Tanimoto, Hitachinaka (JP)

(72) Inventors: Kenichirou YOSHIDA, Hitachinaka (JP); Hideyuki Tanimoto, Hitachinaka (JP)

(73) Assignee: HITACHI KOKI CO, LTD

(21) Appl. No.: 13/590,796

(22) Filed: Aug. 21, 2012

(30) Foreign Application Priority Data
Oct. 28, 2011 (JP) JP2011-236762

(51) Int. Cl. H01R 39/06

(52) U.S. Cl. 310/237

(57) ABSTRACT

A plurality of electrode patterns constituting a plurality of commutator segments are provided on one surface of a commutator disk. A plurality of first communication patterns are provided on the other surface of the commutator disk. The respective communication patterns mutually connect first-group (odd-numbered) electrode patterns between which seven electrode patterns are sandwiched. A connection disk having the same shape as the commutator disk is provided on the commutator disk, and second communication patterns mutually connecting second-group (even-numbered) electrode patterns between which seven electrode patterns are sandwiched are provided on the connection disk.

### CROSS-REFERENCE TO RELATED APPLICATION

The present application claims priority from Japanese Patent Application No. 2011-236762 filed on Oct. 28, 2011, the content of which is hereby incorporated by reference into this application.

### TECHNICAL FIELD OF THE INVENTION

The present invention relates to a disk motor which has a commutator disk and a coil disk to rotationally drive an output shaft, and an electric power tool equipped with the same.

### BACKGROUND OF THE INVENTION

The electric power tools include a grass cutter used for cutting grass or small-diameter trees, and the like. In some types of the electric power tool including a grass cutter, a disk motor is used as an electric motor for rotationally driving an output shaft to which a rotary tool such as a cutting blade is attached. The disk motor has a rotor provided with an approximately disk-like coil disk on which a coil pattern is printed and a commutator disk connected to the coil pattern, as described in Japanese Patent No. 3636700 (Patent Document 1). The rotor is attached to the output shaft. Magnets are arranged to face the coil pattern, and brushes for supplying current to the commutator disk are arranged so as to face the commutator disk.

The number of rotations of the disk motor is determined depending on a voltage supplied from the brushes, current of the disk motor, a coil pattern of the coil disk, magnetic flux of the magnets, the number of brushes (the number of poles), and the like. When the voltage supplied from the brushes and the current of the disk motor are constant, it is possible to set the number of rotations of the disk motor to a desired number of rotations by changing the coil pattern of the coil disk, the magnetic flux of the magnets, and the number of brushes.

FIG. 16A is a plan view showing electrode patterns on one surface side of a commutator disk as a related art which is a target to be developed, FIG. 16B is a plan view showing communication patterns on the other surface side of the commutator disk as the related art transparently viewed from the one surface side, and FIG. 16C is a plan view showing the other surface side of a commutator disk as a comparative example.

A commutator disk 835 has an insulating substrate, and a plurality of electrode patterns 840 and a plurality of one-side second communication patterns 842A are provided on one surface of the insulating substrate. On the other surface of the insulating substrate, a plurality of first communication patterns 841 and a plurality of other-side second communication patterns 842B are provided. The plurality of electrode patterns 840 constitute a plurality of commutator segments. In FIG. 16, the number of commutator segments, that is, the number of electrode patterns is 40. In FIG. 16A, when a specific segment is defined as the 1st segment, respective segments are defined as the 1st to 40th segments in a clockwise direction. The electrode patterns 840 corresponding to odd-numbered segments are defined as “first-group electrode patterns”, and the electrode patterns 840 corresponding to even-numbered segments are defined as “second-group electrode patterns”.

The respective first communication patterns 841 mutually connect the first-group (odd-numbered) electrode patterns 840 between which seven electrode patterns 840 are sandwiched. In FIG. 16, the electrode patterns 840 corresponding to the 1st, 9th, 17th, 25th, and 33rd segments and the first communication patterns 841 mutually connecting them are highlighted by vertical hatching. Interlayer connections (connections between front surface and rear surface) between the electrode patterns 840 and the first communication patterns 841 are achieved by outer through-holes 851 and inner through-holes 852. The outer through-holes 851 extend at outer positions of the respective electrode patterns 840 from the respective electrode patterns 840 toward the other surface side. The inner through-holes 852 extend at inner positions of the respective electrode patterns 840 from the respective electrode patterns 840 toward the other surface side. Focusing on the connection between the 1st segment and the 9th segment, the inner through-holes 852 of the 1st electrode pattern 840 and the outer through-holes 851 of the 9th electrode pattern 840 are connected to each other through the first communication pattern 841. The other electrode patterns 840 belonging to the first group are also connected in the same manner.

The respective second communication patterns 842A on one surface side and the respective second communication patterns 842B on the other surface side mutually connect the second-group (even-numbered) electrode patterns 840 between which seven electrode patterns 840 are sandwiched. In FIG. 16, the electrode patterns 840 corresponding to the 6th, 14th, 22nd, 30th, and 38th segments, and the second communication patterns 842A and the second communication patterns 842B connecting them mutually are highlighted by diagonal hatching. Interlayer connections (connection between a front surface and a rear surface) between the second communication patterns 842A and the second communication patterns 842B are achieved by relay through-holes 855. Focusing on the connection between the 6th and 14th segments, inner through-holes 852 of the 6th electrode pattern 840 and inner through-holes 852 of the 14th electrode pattern 840 are connected to each other through the second communication pattern 842A and the second communication pattern 842B. The other electrode patterns 840 belonging to the second group are also connected in the same manner.

By connecting the electrode patterns 840 in the above manner, proper current to be a source of rotational force can be supplied to the coil disk by the limited number of brushes.

### SUMMARY OF THE INVENTION

The first communication patterns 841 and the second communication patterns 842B are arranged on the other surface side of the above-described commutator disk 835 in a mixed manner, which causes the problem that the area of the substrate (difference between an inner diameter and an outer diameter) cannot be reduced. More specifically, there is such a problem that the outer diameter of the commutator disk cannot be made small or the inner diameter (diameter of a central through-hole) cannot be made large.

An object of the present invention is to provide a disk motor capable of reducing a substrate area of a commutator disk and an electric power tool equipped with the same.

An embodiment of the present invention is a disk motor. The disk motor is provided with: a rotor having a commutator disk and at least one coil disk; a stator having a magnetic flux generating portion facing a coil pattern of the coil disk; a current supplying portion supplying current to the coil pattern via the commutator disk; and an output shaft rotated by rotational force of the rotor, the commutator disk has a first layer provided with a plurality of electrode patterns constituting a plurality of commutator segments and arranged around the output shaft, the plurality of electrode patterns include first-group electrode patterns and second-group electrode patterns, first communication patterns mutually connecting the first-group electrode patterns between which a predetermined number of electrode patterns are sandwiched are provided to the respective first-group electrode patterns, second communication patterns mutually connecting the second-group electrode patterns between which a predetermined number of electrode patterns are sandwiched are provided to the respective second-group electrode patterns, the first and second communication patterns are present on different layers, and a second layer on which at least one of the first and second communication patterns are present and a third layer on which at least the other of the first and second communication patterns are present are provided.

At least either of the first and second communication patterns may be separately present in a plurality of layers. The first and second communication patterns may mutually connect two points different in both circumferential position and radial position at least on one layer. When serial numbers are attached to the plurality of electrode patterns around the output shaft, the first-group electrode patterns may be odd-numbered electrode patterns, and the second-group electrode patterns may be even-numbered electrode patterns. The first and second communication patterns may be separately present in layers on both surfaces of the commutator disk and in a plurality of layers having the coil pattern formed thereon. The rotor may be provided with a connection disk in addition to the commutator disk and the coil disk, and the first and second communication patterns may be separately present in layers on both surfaces of the commutator disk and layers on both surfaces of the connection disk. The disk motor may further include relay conductor portions connecting the first communication patterns between different layers, and the relay conductor portions may be present at positions closer to the output shaft than the electrode patterns. The rotor may be provided with a connection disk in addition to the commutator disk and the coil disk, the first communication patterns may be present on the other surface of the commutator disk, and the second communication patterns may be separately present in layers on both surfaces of the connection disk. The first and second communication patterns may be arranged so that radial positions of the first and second communication patterns fall within a range of presence of the electrode patterns when viewed from a direction of the output shaft. The current supplying portion may have brushes in contact with the plurality of electrode patterns.

Another embodiment of the present invention is an electric power tool equipped with the disk motor described above.

Any combinations of the above-described constituent elements and ones obtained by converting the expression of the present invention among methods, systems, and others are also effective as the aspects of the present invention.

According to the present invention, since the first and the second communication patterns are present in mutually different layers and at least either one of the first and the second communication patterns are separately present in a plurality of layers, a substrate area (difference between an inner diameter and an outer diameter) of the commutator disk can be made small as compared with the case where the first and the second communication patterns are present on one surface of the commutator disk in a mixed manner.

### BRIEF DESCRIPTIONS OF THE DRAWINGS

FIG. 1 is a perspective view of a grass cutter as an electric power tool according to an embodiment of the present invention;

FIG. 2 is a cross-sectional view showing a driving portion of the grass cutter shown in FIG. 1;

FIG. 3 is a plan view showing an inside of a stator shown in FIG. 2;

FIG. 4 is a front view showing a rotor shown in FIG. 2, and a left half of FIG. 4 shows a cross section of the rotor;

FIG. 5A is a plan view showing electrode patterns on a rear surface side of a commutator disk according to a first embodiment;

FIG. 5B is a plan view of communication patterns on a front surface side of the commutator disk transparently viewed from a rear surface side;

FIG. 5C is a plan view showing a front surface side of the commutator disk;

FIG. 6A is a plan view showing communication patterns on a rear surface side of a connection disk according to the first embodiment;

FIG. 6B is a plan view of communication patterns on a front surface side of the connection disk transparently viewed from the rear surface side;

FIG. 6C is a plan view showing a front surface side of the connection disk;

FIG. 7A is a plan view showing electrode patterns on a rear surface side of a commutator disk according to a second embodiment;

FIG. 7B is a plan view of communication patterns on a front surface side of the commutator disk transparently viewed from the rear surface side;

FIG. 7C is a plan view showing a front surface side of the commutator disk;

FIG. 8A is a plan view showing communication patterns on a rear surface side of a connection disk according to the second embodiment;

FIG. 8B is a plan view of communication patterns on a front surface side of the connection disk transparently viewed from the rear surface side;

FIG. 8C is a plan view showing a front surface side of the connection disk;

FIG. 9A is a plan view showing communication patterns on a rear surface side of a connection disk according to a third embodiment;

FIG. 9B is a plan view of communication patterns on a front surface side of the connection disk transparently viewed from the rear surface side;

FIG. 9C is a plan view showing a front surface side of the connection disk;

FIG. 10A is a plan view showing a rear surface side of a first coil disk shown in FIG. 4;

FIG. 10B is a plan view showing a front surface side of the coil disk;

FIG. 11A is a plan view showing a rear surface of a coil disk in the same manner as FIG. 10A for describing a coil pattern of the first coil disk;

FIG. 11B is a plan view showing a front surface of the coil disk in the same manner as FIG. 10B for describing the coil pattern of the first coil disk;

FIG. 12 is a cross-sectional view of a driving portion having a disk motor according to another embodiment;

FIG. 13 is a front view showing a rotor of the disk motor shown in FIG. 12;

FIG. 14A is a plan view showing electrode patterns on a rear surface side of a commutator disk shown in FIG. 13;

FIG. 14B is a plan view of communication patterns on a front surface side of the commutator disk transparently viewed from the rear surface side;

FIG. 14C is a plan view showing a front surface side of the commutator disk;

FIG. 15A is a plan view showing a coil pattern on a rear surface side of a first coil disk shown in FIG. 13;

FIG. 15B is a plan view of a coil pattern on a front surface side of the first coil disk transparently viewed from the rear surface side;

FIG. 16A is a plan view showing electrode patterns on a rear surface side of a commutator disk as a related art;

FIG. 16B is a plan view showing communication patterns on a front surface side of a commutator disk as a comparative example transparently viewed from a rear surface side while omitting the electrode patterns and an insulating substrate; and

FIG. 16C is a plan view showing a front surface side of the commutator disk as the comparative example.

### DESCRIPTIONS OF THE PREFERRED EMBODIMENTS

Hereinafter, preferred embodiments of the present invention will be described in detail with reference to drawings. The same or equivalent constituent elements, members, and others shown in the drawings are denoted by the same reference numerals, and redundant descriptions will be appropriately omitted. Also, the embodiments do not limit the invention, but are shown as examples, and all the characteristics and combinations thereof described in the embodiments are not necessarily essential to the invention.

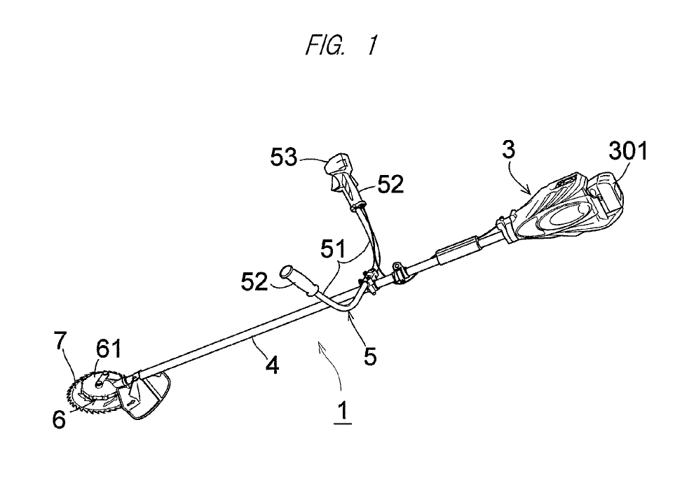

FIG. 1 is a perspective view of a grass cutter 1 according to an embodiment of the present invention. The grass cutter 1 which is an example of an electric power tool is provided with a power source portion 3, a pipe portion 4, a handle portion 5, a driving portion 6, and a cutting blade 7. A battery serving as a power source is detachably attached to the power source portion 3. The pipe portion 4 mechanically connects, namely, couples the power source portion 3 and the driving portion 6 to each other. A wiring (not shown) electrically connecting the power source portion 3 and the driving portion 6 is inserted through the pipe portion 4. Power is supplied from the power source portion 3 to the driving portion 6 by the wiring. The driving portion 6 houses a disk motor within a head housing 61, and it rotationally drives the cutting blade 7 by the power supplied from the power source portion 3. The configuration of the disk motor will be described later.

The handle portion 5 is attached and fixed to an intermediate portion of the pipe portion 4, that is, between the power source portion 3 and the driving portion 6. The handle portion 5 has paired arms 51 and grips 52 are attached to distal ends of the respective arms 51. A throttle 53 is provided to one of the grips 52. An operator controls the throttle 53 to adjust power supply to the driving portion 6 and adjust the number of rotations of the cutting blade 7. The cutting blade 7 is formed in an approximately circular shape and saw teeth are formed on a circumferential edge thereof. A hole (not shown) attached to an output shaft of a disk motor described later is formed at the center of the cutting blade 7.

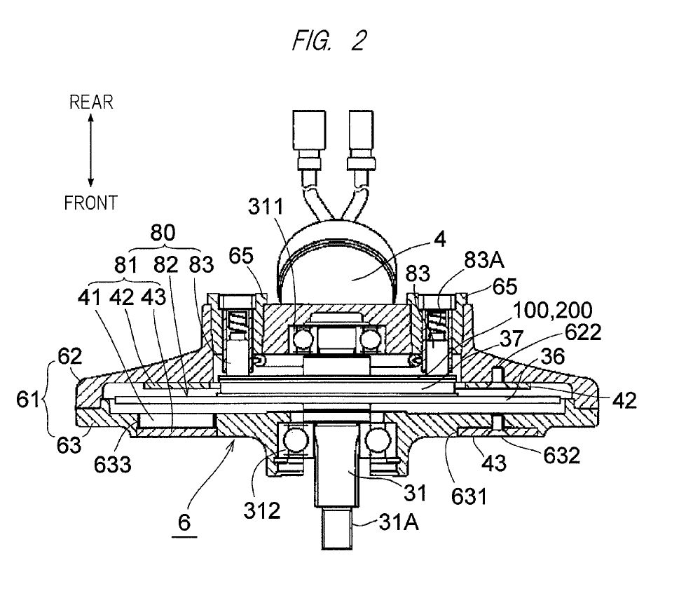

FIG. 2 is a cross-sectional view showing the driving portion 6 of the grass cutter 1 shown in FIG. 1. In FIG. 2, an axial direction of an output shaft 31, that is, an extending direction thereof is shown as a vertical direction. More specifically, a distal end portion of the output shaft 31 is positioned on a lower side, a base end portion thereof is positioned on an upper side, the distal end portion of the output shaft 31 is defined as a front surface of the driving portion 6, and the base end portion thereof is defined as a rear surface of the driving portion 6. The driving portion 6 has a disk motor 80 in the head housing 61. The head housing 61 is formed by combining a cover portion 62 and a base portion 63. The disk motor 80 has a stator 81, a rotor 82, and paired brushes 83. The paired brushes 83 are symmetrically provided around a rotation shaft (output shaft 31) of the disk motor 80, and they are supported by brush holders 65 of the cover portion 62. Each of the brushes 83 is biased toward a commutator disk 100 described later, that is, to a front surface side of the driving portion 6 by a spring 83A so that a distal end surface of the brush 83 abuts on a commutator pattern made of conductor such as copper on the commutator disk 100. The brushes 83 are connected to the power source portion 3 shown in FIG. 1, and they function as current supplying portions that supply current to the coil patterns of the rotor 82 described later.

The stator 81 has magnets 41 serving as a magnetic flux generating portion, and a first yoke 42 and a second yoke 43 which are soft magnetic materials. The first yoke 42 formed in a ring shape is fixed to an inner surface of the cover portion 62 by, for example, screws 622. The second yoke 43 formed in a ring shape and having approximately the same diameter as that of the first yoke 42 is fitted into a ring-shaped groove 631 formed on a lower surface of the base portion 63, and is fixed to the base portion 63 by, for example, screws 632. The magnets 41 are fitted and fixed into holes 633 formed in an inner surface of the base portion 63.

FIG. 3 is a plan view showing an inside of the stator 81 shown in FIG. 2. As illustrated in FIG. 3, for example, disk-like magnets 41, for example, ten pieces, are arranged at equal angular pitches in a circumferential direction. The same number of holes 633 shown in FIG. 2 which house the magnets 41 are also formed in the inner surface of the base portion 63 along a circumferential direction. The center of the stator 81 is approximately coincident with a rotation center of the rotor 82. In the magnets 41 positioned adjacent to each other, their inner surface magnetic poles facing the rotor 82 are different from each other. The magnet 41 is preferably a rare-earth magnet such as a neodymium magnet, but it may be a sintered magnet such as a ferrite magnet. The first yoke 42 and the second yoke 43 are for enhancing magnetic flux density applied to coil patterns of the rotor 82 described later.

As shown in FIG. 2, the rotor 82 has a rotor shaft, that is, the output shaft 31, the commutator disk 100, a connection disk 200, a coil portion 36, and a flange 37. Abase end portion of the output shaft 31 is supported by a bearing 311 fixed to the cover portion 62, a distal end portion of the output shaft 31 is supported by a bearing 312 fixed to the based portion 63, and the output shaft 31 is rotatably supported by the head housing 61. A male screw portion 31A is formed at the distal end portion of the output shaft 31, and the cutting blade 7 shown in FIG. 1 is attached to the output shaft by a fastener (not shown). A rear surface of the commutator disk 100 constitutes a sliding surface to which the brushes 83 contact. Current is supplied from the power source portion 3 shown in FIG. 1 to the coil portion 36 via the brushes 83 and the commutator disk 100.

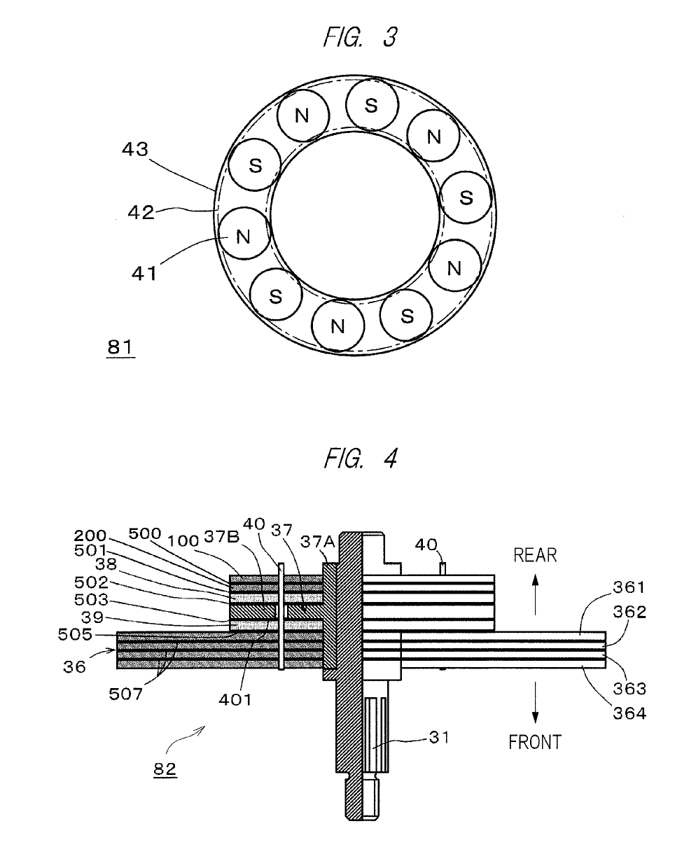

FIG. 4 is a front view showing the rotor 82 shown in FIG. 2, and a left half of FIG. 4 shows a cross section of the rotor 82. As shown in FIG. 4, the flange 37 is coaxially fixed to the output shaft 31. The flange 37 is made of, for example, metal such as aluminum or resin such as nylon, and is composed of a cylindrical portion 37A formed in an approximately cylindrical shape and a disk portion 37B formed in an approximately disk-like shape. The disk portion 37B outwardly projects from an outer peripheral surface of the cylindrical portion 37A in a radial direction at a right angle with respect to the output shaft 31. An insulating plate 38 is bonded and fixed to a rear surface of the disk portion 37B by a sheet-like insulating adhesion layer 502, and an insulating plate 39 is bonded and fixed to a front surface of the disk portion 37B by a sheet-like insulating adhesion layer 503. The outer diameters of the respective insulating plates 38 and 39 are approximately equal to the outer diameter of the disk portion 37B. The connection disk 200 is bonded and fixed to a rear surface of the insulating plate 38 by a sheet-like insulating adhesion layer 501. The commutator disk 100 is bonded and fixed to a rear surface of the connection disk 200 by a sheet-like insulating adhesion layer 500. The coil portion 36 is bonded and fixed to a front surface of the insulating plate 39 by a sheet-like insulating adhesion layer 505. The commutator disk 100, the connection disk 200 and respective coil disks of the coil portion 36 are coaxially stacked on one another.

The coil portion 36 is formed by stacking a first coil disk 361 to a fourth coil disk 364 with interposing sheet-like insulating adhesion layers 507 therebetween. The sheet-like insulating adhesion layer 507 has the same outer diameter as that of each coil disk, and covers approximately a whole surface of each coil disk. The first coil disk 361 to the fourth coil disk 364 have diameters larger than that of the disk portion 37B, and coil patterns described later are formed on both of a front surface and a rear surface thereof. Each of conductor pins 40 penetrating from the commutator disk 100 to the fourth disk 364 electrically connects an electrode pattern corresponding to a predetermined commutator segment of the commutator disk 100 and at least any of coil patterns of the first coil disk 361 to the fourth coil disk 364. Insulating pipes 401 are fitted into through-holes formed in the disk portion 37B, the conductor pins 40 are inserted through the insulating pipes 401, and the pins 40 and the flange 37 are insulated from each other by the insulating pipes 401.

Specific examples of the commutator disk 100 and the connection disk 200 will be described below.

### First Embodiment

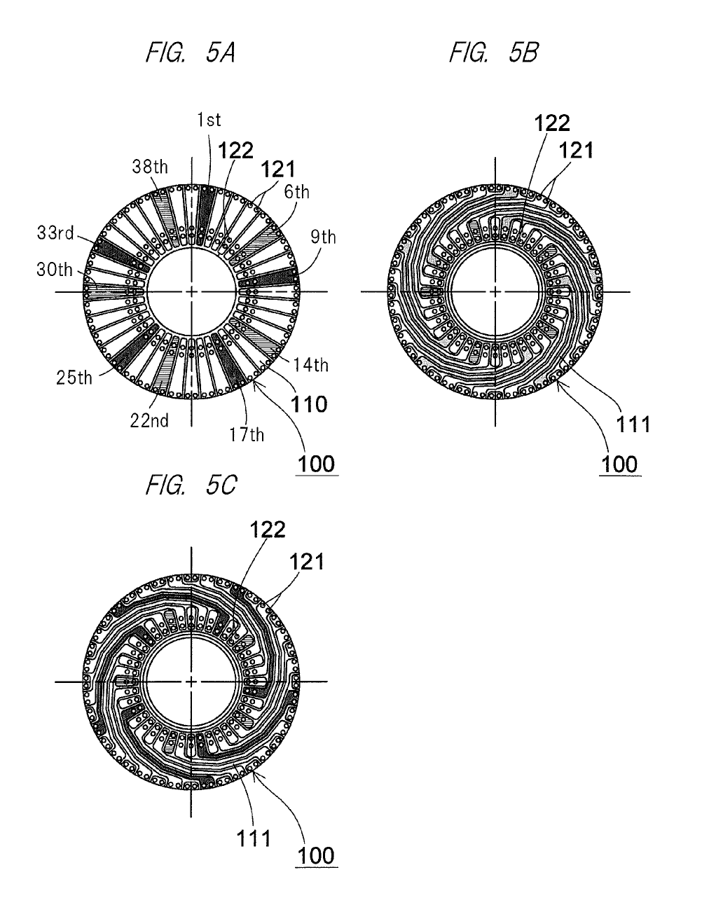

FIG. 5A is a plan view showing electrode patterns on a rear surface side of a commutator disk according to a first embodiment,

FIG. 5B is a plan view of communication patterns on a front surface side of the commutator disk transparently viewed from the rear surface side while omitting electrode patterns and an insulating substrate, and FIG. 5C is a plan view showing a front surface side of the commutator disk. The commutator disk 100 is formed by providing predetermined conductor patterns made of a conductive material such as copper on both surfaces of a disk-like insulating substrate having an opening formed at the center thereof. The insulating substrate is formed of, for example, insulating resin such as a glass-fiber reinforced epoxy resin substrate. Details of the conductor patterns will be described later.

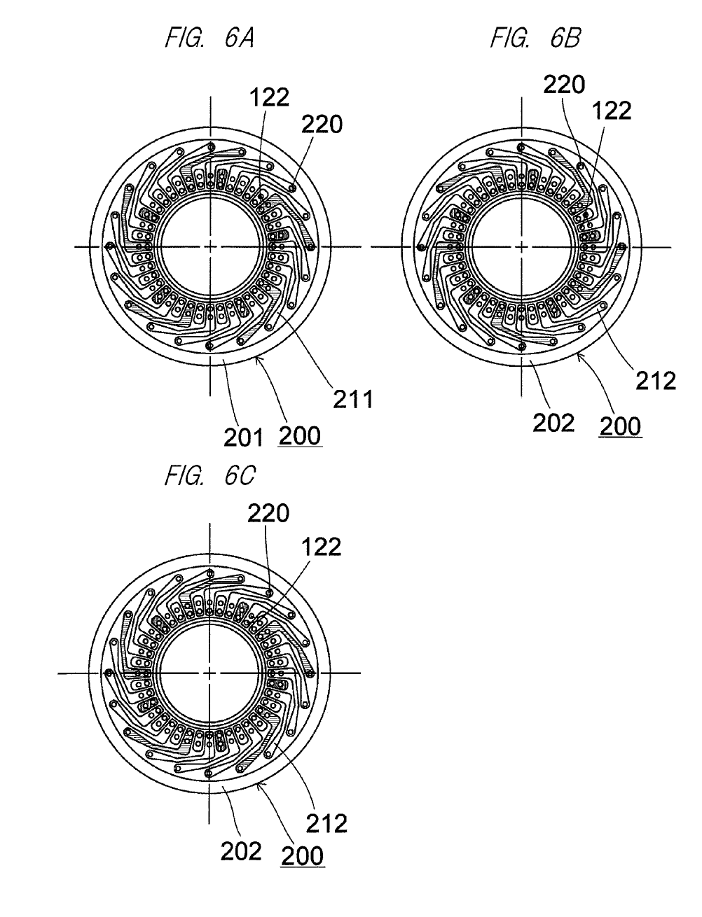

FIG. 6A is a plan view showing communication patterns on a rear surface side of a connection disk according to the first embodiment, FIG. 6B is a plan view of communication patterns on a front surface side of the connection disk transparently viewed from the rear surface side while omitting the communication pattern on the rear surface side and an insulating substrate, and FIG. 6C is a plan view showing a front surface side of the connection disk. The connection disk 200 is formed by providing predetermined conductor patterns made of a conductive material such as copper on both surfaces of a disk-like insulating substrate having an opening formed at the center thereof. The insulating substrate is formed of, for example, insulating resin such as a glass-fiber reinforced epoxy resin substrate like the insulating substrate of the commutator disk 100. Details of the conductor patterns will be described later.

As shown in FIG. 5A, a plurality of electrode patterns 110 constituting a plurality of commutator segments are provided on a rear surface of the commutator disk 100 to which the brushes 83 contact. The paired brushes 83 slidably contact to rear surfaces, that is, exposure surfaces of the electrode patterns 110 constituting the commutator segments as shown in FIG. 2, so that current is supplied to the electrode patterns 110. In the illustrated example, the number of commutator segments, that is, the number of electrode patterns 110 is 40. In FIG. 5A, when a specific segment is defined as the 1st segment, the respective segments are defined as the 1st segment to the 40th segment in a clockwise direction. The electrode patterns 110 corresponding to odd-numbered segments are defined as “first-group electrode patterns”, and the electrode patterns 110 corresponding to even-numbered segments are defined as “second-group electrode patterns”. The numbers of the respective segments and classification of the first and second groups hold true for the subsequent embodiments.

As shown in FIGS. 5B and 5C, a plurality of first communication patterns 111 are provided on a front surface of the commutator disk 100. The number of first communication patterns 111 is 20 in the illustrated example. As shown in FIG. 5A, the respective first communication patterns 111 mutually connect first-group electrode patterns 110 for every eight pieces in a circumferential direction. Seven electrode patterns 110 are arranged between the first communication patterns 111 connected mutually. In FIG. 5, the first communication patterns 111 mutually connect odd-numbered electrode patterns 110, and 20 pieces of first communication patterns 111 constitute the first-group electrode patterns. In FIG. 5A, the electrode patterns 110 corresponding to the 1st, 9th, 17th, 25th, and 33rd segments and the first communication patterns 111 mutually connecting them are highlighted by vertical hatching.

The electrode patterns 110 and the first communication patterns 111 are connected by relay conductor portions in outer through-holes 121 and inner through-holes 122 penetrating between a rear surface and a front surface of the insulating substrate of the commutator disk 100. The outer through-holes 121 have relay conductor portions extending from the respective electrode patterns 110 toward the front surface side of the commutator disk 100 at radially outer portions of the respective electrode patterns 110.

The inner through-holes 122 have relay conductor portions extending from the respective electrode patterns 110 toward the front surface side of the commutator disk 100 at radially inner portions of the respective electrode patterns 110. If the electrode pattern 110 and the first communication pattern 111 can be electrically connected, the outer through-holes 121 and the inner through-holes 122 may be through-holes whose inner surfaces are plated with a high thermal conducting material such as copper, or they may be filled with a high thermal conducting material such as copper. Incidentally, one inner through-holes 122 of some electrode patterns 110, for example, the inner through-holes 122 positioned farther away from the center constitute insertion holes into which the conductor pins 40 shown in FIG. 4 are inserted.

The inner through-holes 122 provided in the electrode patterns of the even-numbered segments counted from the 1st segment, that is, those provided in the second-group electrode patterns 110 extend up to the front surface side of the connection disk 200.

Focusing on the connection between the 1st segment and the 9th segment shown in FIG. 5A, the inner through-holes 122 of the 1st electrode pattern 110 and the outer through-holes 121 of the 9th electrode pattern 110 are connected to each other by the first communication pattern 111. Regarding the other odd-numbered segments belonging to the first group, the inner through-holes 122 and the outer through-holes 121 of the electrode patterns 110 shifted by eight pieces in a clockwise direction in FIG. 5A are connected mutually by the first communication patterns 111. Each of the first communication patterns 111 is formed to have a pattern shape whose radial position (distance from the center) varies as an angular position thereof around a center axis of the commutator disk 100 changes. In FIG. 5B, the first communication pattern 111 has a pattern shape whose distance from the center becomes farther as it extends in a clockwise direction.

As shown in FIG. 6A, a plurality of rear-surface-side second communication patterns 211 are provided on a rear surface of the connection disk 200 to which the commutator disk 100 is connected. As shown in FIG. 6B and FIG. 6C, a plurality of front-surface-side second communication patterns 212 are provided on a front surface side of the connection disk 200. In the illustrated example, the numbers of the rear-surface-side second communication patterns 211 and the front-surface-side second communication patterns 212 are 20, respectively. The respective rear-surface-side second communication patterns 211 and the respective front-surface-side second communication patterns 212 mutually connect the second-group electrode patterns 110 for every eight pieces in a circumferential direction. Seven electrode patterns 110 are arranged between the first communication patterns 111 connected mutually. In FIG. 5A and FIG. 6, the electrode patterns 110 corresponding to the 6th, 14th, 22nd, 30th, and 38th segments, and the rear-surface-side second communication patterns 211 and the front-surface-side second communication patterns 212 mutually connecting them are highlighted by diagonal hatching.

The rear-surface-side second communication patterns 211 and the front-surface-side second communication patterns 212 are connected by relay conductor portions of relay through-holes 220 penetrating between a rear surface and a front surface of the insulating substrate of the connection disk 200. The relay through-holes 220 are positioned at radially outer portions relative to the inner through-holes 122, and each of them has a relay conductor portion that electrically connects a radially outer portion of each of the rear-surface-side second communication patterns 211 and a radially outer portion of each of the front-surface-side second communication patterns 212. If the second communication patterns 212 on the rear surface side and the front surface side can be electrically connected, the relay through-hole 220 may be a through-hole whose inner surface is plated with a high thermal conducting material such as copper, or it may be filled with a high thermal conducting material such as copper.

Focusing on the connection between the 6th and 14th segments shown in FIG. 5A, the inner through-holes 122 of the 6th electrode pattern 110 and the inner through-holes 122 of the 14th electrode pattern 110 are connected to each other by the rear-surface-side second communication pattern 211 and the front-surface-side second communication pattern 212. Regarding the other even-numbered segments belonging to the second group, the inner through-holes 122 of the electrode patterns shifted by eight pieces in a clockwise direction in FIG. 6A are similarly connected by the communication patterns 211 and 212. Each of the rear-surface-side second communication patterns 211 extends in a clockwise direction in FIG. 6A and has a pattern shape whose radial position varies as an angular position thereof in a circumferential direction changes. On the other hand, each of the front-surface-side second communication patterns 212 extends in the counterclockwise direction in FIG. 6B and has a pattern shape whose radial position varies as an angular position thereof in the circumferential direction changes. Therefore, in the connection disk 200 illustrated, the distance from the center becomes long in the rear-surface-side second communication pattern 211 as it advances in a clockwise direction in FIG. 6A, whereas the distance from the center becomes short in the front-surface-side second communication pattern 212 as it advances in the clockwise direction.

The ranges in a radial direction of all of the first communication patterns 111, the rear-surface-side second communication patterns 211, and the front-surface-side second communication patterns 212 fall within the ranges in a radial direction of the electrode patterns 110 around the output shaft 31. In this embodiment, the first communication patterns 111 connecting the first-group (odd-numbered) electrode patterns 110 to each other are provided on a rear surface of the commutator disk 100. The rear-surface-side second communication patterns 211 and the front-surface-side second communication patterns 212 connecting the second-group (even-numbered) electrode patterns 110 are provided on both surfaces of the connection disk 200, respectively.

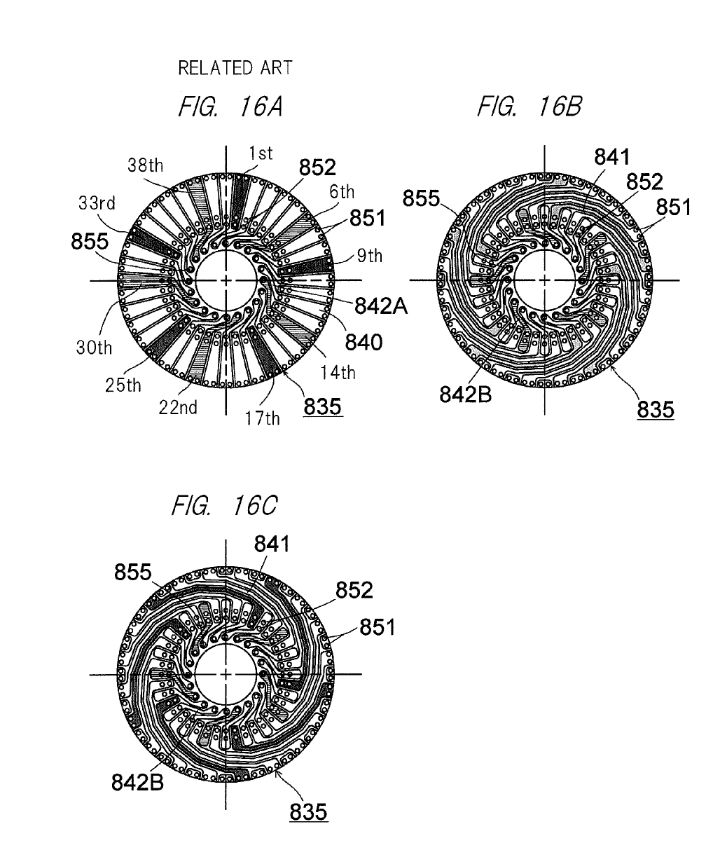

In the commutator disk 835 of the comparative example shown in FIG. 16, the electrode patterns 840 are connected to each other by layered communication patterns provided on both surfaces of the disk, that is, two-layered communication patterns. On the other hand, in this embodiment, the electrode patterns 110 are connected to each other by the communication patterns of a total of three layers including the rear surface of the commutator disk 100 and both surfaces of the connection disk 200. Thus, in this embodiment, the communication patterns mutually connecting the second-group (even-numbered) electrode patterns 110, that is, the rear-surface-side second communication patterns 842A and the front-surface-side second communication patterns 842B in FIG. 16 are not provided to the commutator disk 100. Thereby, even if the outer diameter of the commutator disk 100 is set to be equal to that of the commutator disk 835 in the comparative example, the inner diameter of the commutator disk 100 can be made large. More specifically, a substrate area (difference between an inner diameter and an outer diameter) of the commutator disk 100 can be made small. If the inner diameter of the commutator disk 100 can be made large, the diameter of the output shaft 31 can be made large, and the degree of freedom of design can be advantageously enhanced.

Incidentally, ring-like conductor patterns 201 and 202 whose thicknesses from the substrate surface are approximately equal to those of the rear-surface-side second communication pattern 211 and the front-surface-side second communication pattern 212 are formed on ring-like regions of the outer peripheral portions on both surfaces of the connection disk 200, that is, non-formation regions of the communication patterns, respectively. Thereby, an area of the adhesion layer 500 between the commutator disk 100 and the connection disk 200 and an area of an adhesion layer 501 between the connection disk 200 and the insulating plate 38 can be made large, and adhesiveness of these adhesion layers can be enhanced.

As a modified example of the connection disk 200, instead of the rear-surface-side second communication patterns 211 and the front-surface-side second communication patterns 212, for example, second communication patterns (not shown) having the same shape as the first communication patterns 111 shown in FIG. 5B and FIG. 5C and having their angular positions in the circumferential direction shifted by one segment relative to the first communication patterns 111 may be provided on either one of the rear surface side and the front surface side of the connection disk 200, and the second-group electrode patterns 110 may be connected mutually by the second communication patterns. The illustration of ring-like conductor patterns 201 and 202 in this aspect is omitted. Thus, a single-sided substrate having conductor patterns provided on one surface may be adopted as an aspect of the connection disk 200. Alternatively, if the first communication patterns 111 are provided on the other surface of the connection disk 200, the commutator disk 100 serves as a single-sided substrate.

### Second Embodiment

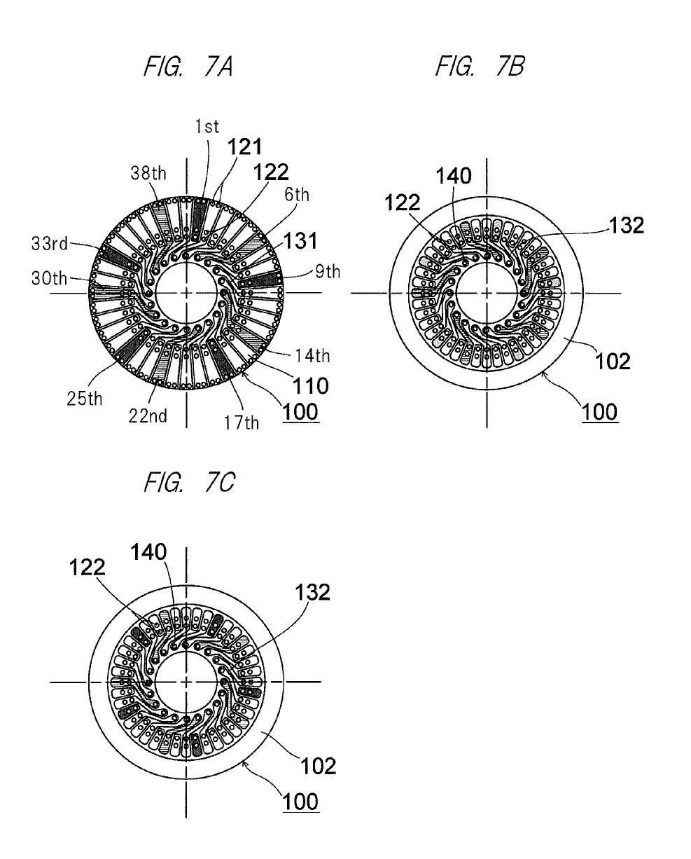

FIG. 7A is a plan view showing electrode patterns on a rear surface side of a commutator disk according to a second embodiment,

FIG. 7B is a plan view of communication patterns on a front surface side of the commutator disk transparently viewed from the rear surface side while omitting electrode patterns and an insulating substrate, and FIG. 7C is a plan view showing the front surface side of the commutator disk.

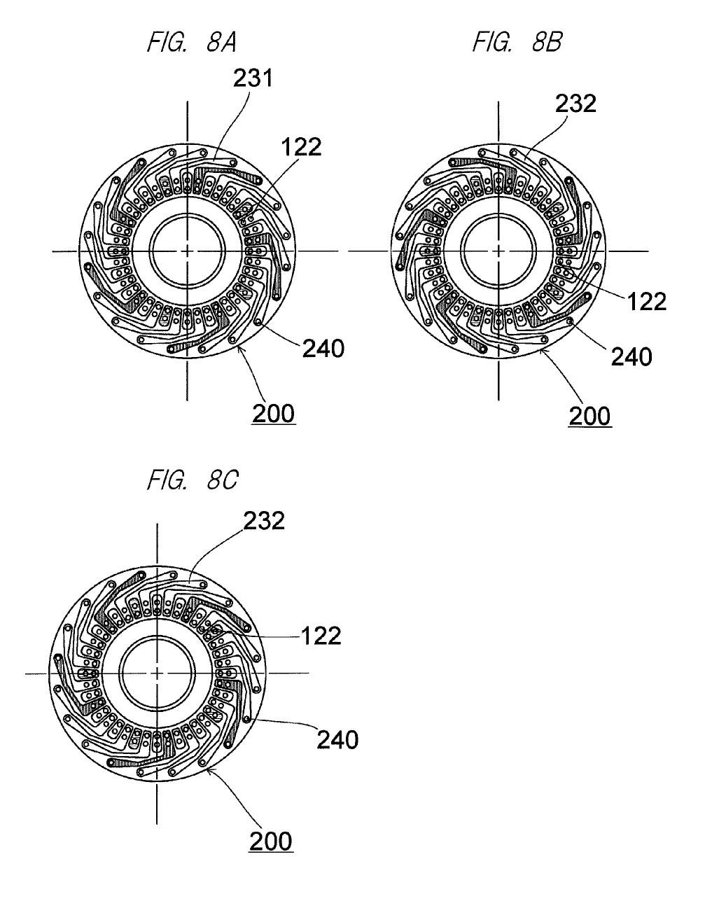

FIG. 8A is a plan view showing communication patterns on a rear surface side of a connection disk according to the second embodiment, FIG. 8B is a plan view of communication patterns on a front surface side of the connection disk transparently viewed from the rear surface side while omitting communication patterns on the rear surface side and an insulating substrate, and FIG. 8C is a plan view showing the front surface side of the connection disk. Different points from the first embodiment will be mainly described below, and descriptions of points in common with the first embodiment will be properly omitted.

As shown in FIG. 7A, in addition to the electrode patterns 110, rear-surface-side second communication patterns 131 are provided on a rear surface of a commutator disk 100. The rear-surface-side second communication patterns 131 extend inwardly in a radial direction from inner side end portions of the electrode patterns 110. As shown in FIGS. 7B and 7C, front-surface-side second communication patterns 132 are provided on a front surface of the commutator disk 100. The numbers of rear-surface-side second communication patterns 131 and front-surface-side second communication patterns 132 are 20 in the illustrated example, respectively. The respective rear-surface-side second communication patterns 131 and the respective front-surface-side second communication patterns 132 connect the second-group (even-numbered) electrode patterns 110 between which seven electrode patterns 110 are sandwiched. In FIG. 7, the electrode patterns 110 corresponding to the 6th, 14th, 22nd, 30th, and 38th segments, and the rear-surface-side second communication patterns 131 and the front-surface-side second communication patterns 132 connecting them mutually are highlighted by diagonal hatching.

The rear-surface-side second communication patterns 131 and the front-surface-side second communication patterns 132 are connected by relay conductor portions of relay through-holes 140 penetrating between a front surface and a rear surface of an insulating substrate of the commutator disk 100. The relay through-hole 140 is positioned at a radially inner portion relative to the inner through-hole 122, and has the relay conductor portion electrically connecting inner end portions of each rear-surface-side second communication pattern 131 and each front-surface-side second communication pattern 132. The relay through-hole 140 may be a through-hole whose inner surface is plated with a high thermal conducting material such as copper, or it may be filled with a high thermal conducting material such as copper. Interlayer connections between the front-surface-side second communication patterns 132 and the electrode patterns 110 are achieved by the inner through-holes 122.

Focusing on the connection between the 6th and 14th segments shown in FIG. 7A, the inner through-hole 122 of the 6th electrode pattern 110 and the inner through-hole 122 of the 14th electrode pattern 110 are connected mutually by the rear-surface-side second connection patterns 131 and the front-surface-side second communication pattern 132. Regarding the other even-numbered segments belonging to the second group, the electrode patterns 110 shifted by eight pieces in FIG. 7 are similarly connected mutually by the communication patterns 131 and 132. Each of the rear-surface-side second communication patterns 131 and the front-surface-side second communication patterns 132 has a pattern shape whose radial position varies as an angular position thereof in the circumferential direction of the commutator disk 100 changes. The distance of the rear-surface-side second communication patterns 131 from the center becomes long as it advances in a clockwise direction in FIG. 7A, whereas the distance of the front-surface-side second communication pattern 132 from the center becomes short as it advances in the clockwise direction.

As shown in FIG. 8A, a plurality of rear-surface-side first communication patterns 231 are provided on a rear surface of the connection disk 200. As shown in FIG. 8B and FIG. 8C, a plurality of front-surface-side first communication patterns 232 are provided on a front surface of the connection disk 200. The numbers of rear-surface-side first communication patterns 231 and front-surface-side first communication patterns 232 are 20 in the illustrated example, respectively. The respective rear-surface-side first communication patterns 231 and the respective front-surface-side first communication patterns 232 mutually connect the first-group electrode patterns 110 for every eight pieces in the circumferential direction. Seven electrode patterns 110 are arranged between the electrode patterns 110 connected mutually. As shown in FIG. 7 and FIG. 8, the electrode patterns 110 corresponding to the 1st, 9th, 17th, 25th, and 33rd segments, and the rear-surface-side first communication patterns 231 and the front-surface-side first communication patterns 232 connecting the electrode patterns 110 mutually are highlighted by vertical hatching. Interlayer connections between the rear-surface-side first communication patterns 231, the front-surface-side first communication patterns 232, and the electrode patterns 110 are achieved by relay conductor portions of the inner through-holes 122. Interlayer connections between the rear-surface-side first communication patterns 231 and the front-surface-side first communication patterns 232 are achieved by relay conductor portions of relay through-holes 240. The relay through-hole 240 is positioned at a radially outer portion relative to the inner through-hole 122, and has the relay conductor portion mutually connecting the radially outer portions of each rear-surface-side first communication pattern 231 and each front-surface-side first communication pattern 232. The relay through-hole 240 may be a through-hole whose inner surface is plated with a high thermal conducting material such as copper, or it may be filled with a high thermal conducting material such as copper.

Focusing on the connection between the 1st and 9th segments shown in FIG. 7A, the inner through-hole 122 of the 1st electrode pattern 110 and the inner through-hole 122 of the 9th electrode pattern 110 are connected to each other by the rear-surface-side first communication pattern 231 and the front-surface-side first communication pattern 232. Regarding the other odd-numbered electrode patterns 110 belonging to the first group, the electrode patterns 110 shifted by eight pieces in FIG. 8 are similarly connected mutually by the communication patterns 231 and 232. Each of the rear-surface-side first communication patterns 231 and the front-surface-side first communication patterns 232 has a pattern shape whose radial position varies as an angular position thereof in the circumferential direction of the connection disk 200 changes. The distance of the rear-surface-side first communication pattern 231 from the center becomes long as it advances in a clockwise direction in FIG. 8A, whereas the distance of the front-surface-side first communication pattern 232 from the center becomes short as it advances in the clockwise direction.

In this embodiment, the rear-surface-side first communication patterns 231 and the front-surface-side first communication patterns 232 mutually connecting the first-group (odd-numbered) electrode patterns 110 are provided on both surfaces of the connection disk 200, respectively. The rear-surface-side second communication patterns 131 and the front-surface-side second communication patterns 132 connecting the second-group (even-numbered) electrode patterns 110 are provided on both surfaces of the commutator disk 100, respectively. More specifically, in this embodiment, the electrode patterns 110 are connected mutually by the communication patterns of a total of four layers including both surfaces of the commutator disk 100 and both surfaces of the connection disk 200. Thus, since no communication patterns (corresponding to the first communication patterns 841 in FIG. 16) mutually connecting the first-group (odd-numbered) electrode patterns 110 are provided on the commutator disk 100, the lengths of the electrode patterns 110 in a radial direction can be made short.

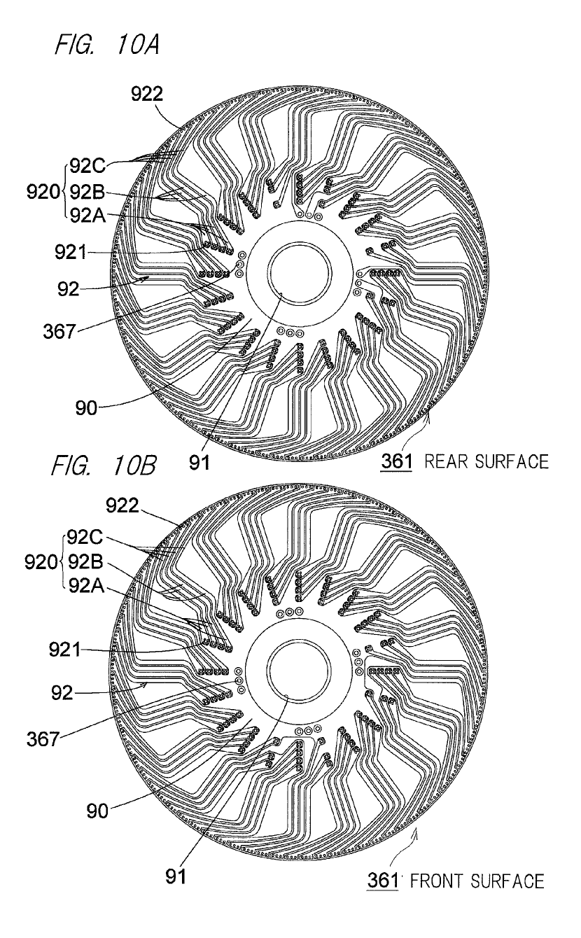

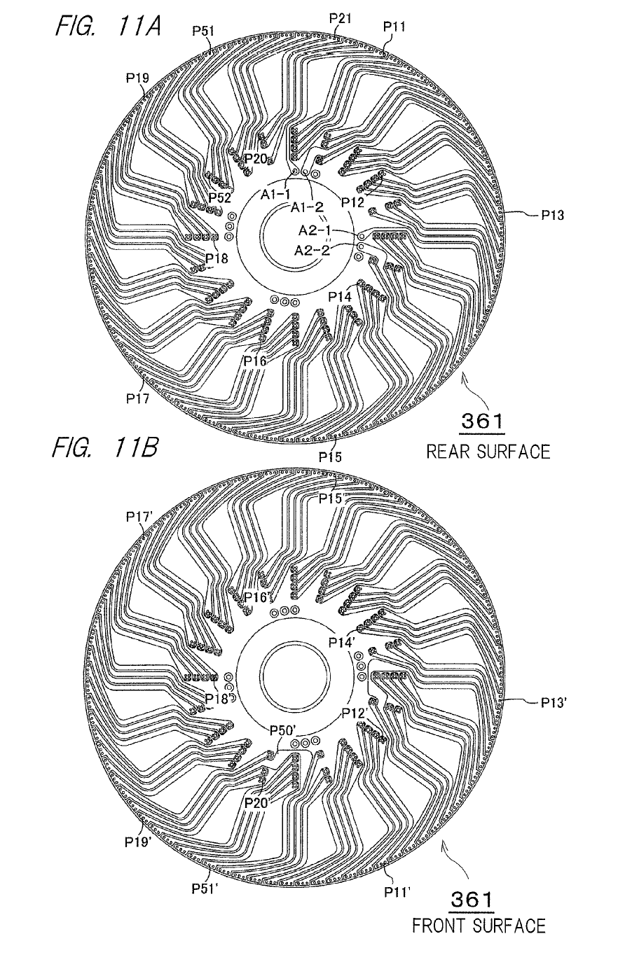

Since the first communication pattern 841 shown in FIG. 16 connects segments separated from each other by only one layer, a length thereof in a radial direction becomes long, and the length of the electrode pattern 110 in a radial direction also becomes long correspondingly. On the contrary, in the commutator disk 100, the outer diameter can be reduced while the inner diameter of the commutator disk 100 is made equal to that of the commutator disk 835 shown in FIG. 16. More specifically, a substrate area (difference between an inner diameter and an outer diameter) of the commutator disk 100 can be made small. When the outer diameter of the commutator disk 100 is made small, a radial pattern group 92B (current path contributing to rotational force) described later in FIG. 10 and the like can be made long, and the driving force of the disk motor 80 can be increased. Further, since the inner diameter of the first yoke 42 shown in FIG. 2 and FIG. 3 can be made small without increasing the outer diameter thereof, the density of magnetic flux applied to the radial pattern group 92B can be further increased, so that the driving force of the disk motor 80 is further increased.

Incidentally, a ring-like conductor pattern 102 whose thickness from the substrate surface is approximately equal to that of the front-surface-side second communication pattern 132 is formed on a ring-like region of an outer peripheral portion of a front surface of the commutator disk 100, that is, a non-formation region of the communication patterns. Thereby, an area of an adhesion layer 500 between the commutator disk 100 and the connection disk 200 can be made large, and adhesiveness between them can be enhanced.

### Third Embodiment

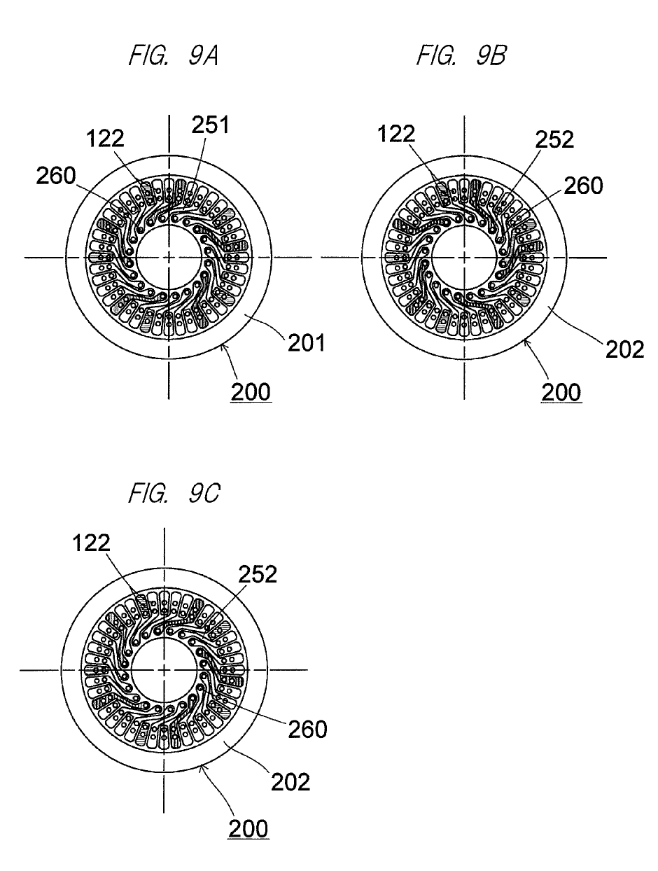

FIG. 9A is a plan view showing communication patterns on a rear surface side of a connection disk according to a third embodiment, FIG. 9B is a plan view of communication patterns on a front surface side of the connection disk transparently viewed from the rear surface side while omitting the communication patterns on the rear surface side and an insulating substrate, and FIG. 9C is a plan view showing a front surface side of the connection disk.

In this embodiment, since the commutator disk 110 is equal to that of the second embodiment, illustration and description thereof are omitted. Different points from the second embodiment will be mainly described below, and description of points in common with the second embodiment will be properly omitted.

As shown in FIG. 9A, a plurality of rear-surface-side first communication patterns 251 are provided on a rear surface of a connection disk 200. As shown in FIGS. 9B and 9C, a plurality of front-surface-side first communication patterns 252 are provided on a front surface of the connection disk 200. The numbers of rear-surface-side first communication patterns 251 and front-surface-side first communication patterns 252 are 20 in the illustrated example, respectively. The respective rear-surface-side first communication patterns 251 and the respective front-surface-side first communication patterns 252 mutually connect the first-group electrode patterns 110 for every eight pieces in the circumferential direction. Seven electrode patterns are arranged between the communication patterns 251 and 252 connected mutually. In FIG. 9, the electrode patterns 110 corresponding to the 1st, 9th, 17th, 25th, and 33rd segments, and the rear-surface-side first communication patterns 251 and the front-surface-side first communication patterns 252 connecting them mutually are highlighted by vertical hatching. Interlayer connections between the rear-surface-side first communication patterns 251, the front-surface-side first communication patterns 252, and the electrode patterns 110 are achieved by relay conductors of inner through-holes 122. The rear-surface-side first communication patterns 251 and the front-surface-side first communication patterns 252 are connected by relay conductor portions of relay through-holes 260. The relay through-holes 260 are positioned at radially inner portions relative to the inner through-holes 122 and have relay conductor portions electrically connecting radially inner portions of the respective rear-surface-side first communication patterns 251 and the respective front-surface-side first communication patterns 252. Each of the relay through-holes 260 may be a through-hole whose inner surface is plated with a high thermal conducting material such as copper, or it may be filled with a high thermal conducting material such as copper.

In this embodiment, since the relay through-holes 260 are provided at radially inner positions relative to the inner through-holes 122, the rear-surface-side first communication patterns 251 and the front-surface-side first communication patterns 252 fall in the radially inner positions relative to the inner through-holes 122 unlike the case of the second embodiment shown in FIG. 8 in which the relay through-holes 240 are provided at radially outer positions relative to the inner through-holes 122. Thus, since any communication patterns do not extend to the radially outer side relative to the inner through-holes 122, for example, when the brushes 83 are small, the outer diameter of the commutator disk 100 can be made further smaller than that in the second embodiment by making the electrode patterns 110 small.

FIG. 10A is a plan view showing a rear surface side of the first coil disk 361 shown in FIG. 4. FIG. 10B is a plan view showing a front surface side of the same coil disk. Incidentally, since the other coil disks have the same structure and the same coil pattern as those of the first coil disk 361, only the first coil disk 361 will be described here.

The first coil disk 361 is formed by providing respective coil patterns 92 on both surfaces of a disk-like insulating substrate 90. The insulating substrate 90 is formed of, for example, insulating resin such as a glass-fiber reinforced epoxy resin substrate. In a through-hole 91 positioned at the center of the insulating substrate 90, the cylindrical portion 37A shown in FIG. 4 is inserted. Three holes serving as pin insertion holes 367 are formed for every angle of 90° around the center of the insulating substrate 90, and 12 pin insertion holes are formed in total. Distances from the respective pin insertion holes 367 to the center of the insulating substrate 90 are equal to one another. Each pin insertion hole 367 is connected to one of the inner through-holes 122 of a predetermined electrode pattern 110 on the commutator disk 100 via the pin 40 shown in FIG. 4.

The coil patterns 92 made of a conductive material such as copper are formed by performing etching via a mask to both surfaces of the disk-like insulating substrate 90 on which a conductive material such as copper foil has been stacked. The coil patterns 92 include 20 partial coil pattern groups 920 each composed of four-lined partial coil pieces which are close to one another and have approximately the same width on one surface (one layer) of the insulating substrate 90. The partial coil pattern groups 920 are each formed of an inner communication pattern group 92A, a radial pattern group 92B, and an outer communication pattern group 92C which are laid integrally with each other. The inner communication pattern groups 92A on both surfaces are electrically connected mutually by through-holes 921 formed near end portions thereof. The outer communication pattern groups 92C on both surfaces are electrically connected mutually by through-holes 922 formed near end portions thereof. The radial pattern groups 92B extend outwardly from the center side of the insulating substrate 90 in a radial direction and are connected to the inner communication pattern groups 92A and the outer communication pattern groups 92C.

The radial pattern groups 92B on both surfaces are present at approximately the same positions in a radial direction. The radial pattern groups 92B face the circumference of the arranged magnets 41 shown in FIG. 2 and FIG. 3, that is, the circumferential positions on which the centers of the respective magnets 41 are arranged. Therefore, the radial pattern groups 92B move along the magnets 41 in accordance with the rotation of the respective coil disks. Rotational force is applied to the rotor 82 by electromagnetic force between current flowing in the radial pattern groups 92B and magnetic field generated by the magnets 41.

The radial pattern groups 92B on the respective surfaces are present at equal angle pitches from the center of the insulating substrate 90. Therefore, regions where no coil pattern 92 is present exist between the adjacent radial pattern groups 92B on a surface of the insulating substrate 90.

FIG. 11A is a plan view showing a rear surface of a coil disk in the same manner as FIG. 10A for describing the coil pattern on the first coil disk 361, and FIG. 11B is a plan view showing a front surface of the first coil disk 361. FIGS. 11A and 11B are equal to FIG. 10A and FIG. 10B except for reference numerals attached to FIGS. 11A and 11B.

The coil pattern 92 of the first coil disk 361 includes two coils. A starting point of one of the coils is denoted by a reference sign A1-1 and an end point thereof is denoted by a reference sign A1-2 in FIG. 11A. A starting point of the other coil is denoted by a reference sign A2-1 and an end point thereof is denoted by a reference sign A2-2. The one coil leads from the starting point A1-1 to points P11, P11′, P12′, P12, P13, P13′, . . . P19′, and P20′. Thereby, a coil turning in a clockwise direction from the starting point A1-1 is formed on the rear surface. The coil turns four times in total in a clockwise direction in the same manner to reach the point P50′. Then, it turns four times in total from the point P50′ via points P51′, P51, . . . in a counterclockwise direction to reach the end point A1-2. Similarly, the other coil also leads from the starting point A2-1 to the end point A2-2.

The four disks of the first coil disk 361 to the fourth coil disk 364 thus configured are stacked on one another in an axial direction of the output shaft 31, thereby constituting the coil portion 36. Coils of different coil disks are electrically connected to each other by the pins 40 which have been already described in FIG. 4. For example, one coil provided on the first coil disk 361 and the electrode patterns 110 on the commutator disk 100 are connected so that when the electrode pattern 110 to which the starting point A1-1 is connected is conducted to one brush 83, the electrode pattern 110 to which the end point A1-2 is connected is conducted to the other brush 83. The same holds true for the other coil having the starting point A2-1 and the end point A2-2. Further, the same holds true for the coils of the other coil disks. Current is fed to the respective coils from the brushes 83 via the commutator disk 100 so that the radial pattern groups 92B of the respective coil disks which pass through magnetic pole surfaces of the magnets 41 generate rotational torques working in the same direction. Incidentally, the coil patterns 92 formed on the respective coil disks can be connected in series by shifting angles (phases) of the respective coil disks around the output shaft 31 by a predetermined angle.

A manufacturing method of the disk motor 80 will be described briefly below.

Etching is performed via a mask to both surfaces of the disk-like insulating substrate on which a conductive material such as copper foil has been stacked (etching step). Required through-holes and pin insertion holes are formed before or after the etching process. Thereby, four coil disks 361 to 364 on which coil patterns 92 shown in FIG. 10A and the like have been formed are prepared. The commutator disk 100 and the connection disk 200 on which patterns (the electrode patterns 110, the respective communication patterns, and the like) according to any of the first to third embodiments have been formed are prepared similarly.

As shown in FIG. 4, after the pins 40 are inserted into the disk portion 37B, members to be assembled such as the commutator disk 100 and others are stacked on the flange 37 with interposing therebetween the sheet-like adhesion layers 500 to 503, 505, and 507 in a prepreg state, which are thin sheets obtained by impregnating a glass fabric base material with epoxy resin to put the same in a semi-cured state, and the assembled body thus obtained is set in a die and is pressurized in a stacking direction in a heated state by hot press (bonding step). Prior to the hot press, the pins 40 and the respective coil disks 361 to 364 in a stacked state are soldered in advance. Further, after the hot press, the commutator disk 100 and the pins 40 are soldered and unnecessary portions of the protruding pins 40 are cut off. The rotor 82 thus obtained shown in FIG. 4 is combined with the stator 81 and the brushes 83 as shown in FIG. 2, thereby manufacturing the disk motor 80.

Another embodiment which is not provided with the connection disk 200 will be described below.

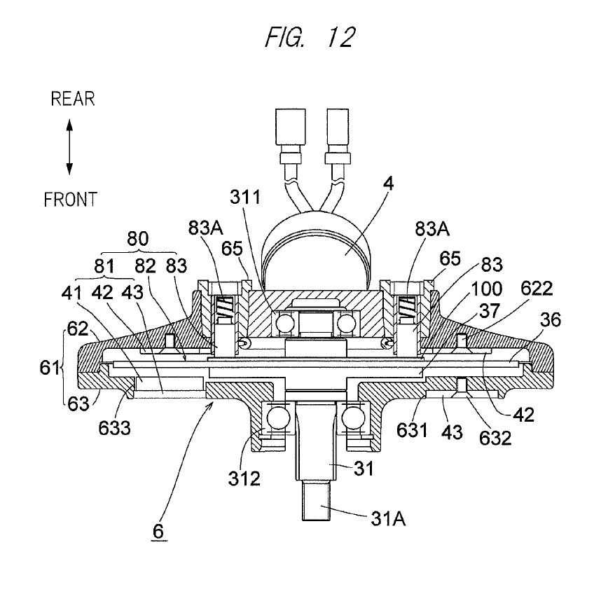

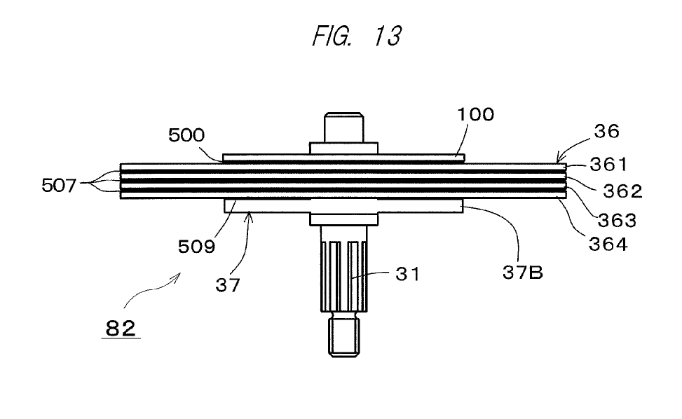

FIG. 12 is a cross-sectional view of the driving portion 6 having a disk motor 80 according to another embodiment. FIG. 13 is a front view showing a rotor 82 of the disk motor shown in FIG. 12. The disk motor 80 is different in structure of the rotor 82 from that shown in FIG. 2, but the former is equal to the latter in the other points. Different points therebetween will be mainly described below.

The coil portion 36 of the rotor 82 is bonded and fixed to a rear surface of the disk portion 37B of the flange 37 by a sheet-like adhesion layer 509 having the same shape as the disk portion 37B. As described above, the coil portion 36 is composed of a stacked body of the first coil disk 361 to the fourth coil disk 364. The commutator disk 100 is bonded and fixed to a rear surface of the coil portion 36, that is, on an upper surface of the first coil disk 361 in FIG. 12 and FIG. 13 by a sheet-like adhesion layer 500. No pin is used for the interlayer connection, and connection between the commutator disk 100 and the respective coil disks is achieved by through-holes.

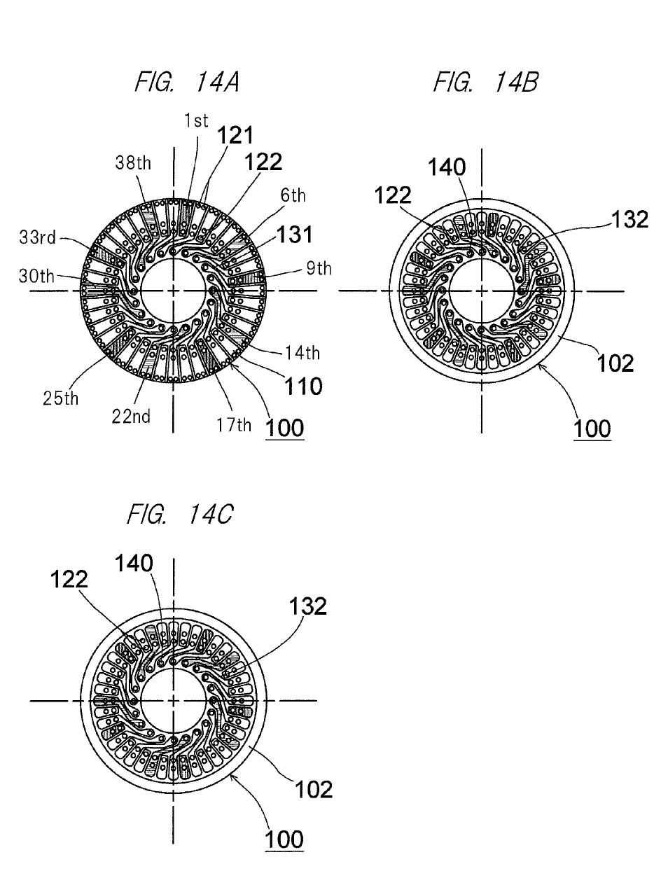

FIG. 14A is a plan view showing electrode patterns on a rear surface side of the commutator disk 100 shown in FIG. 13. FIG. 14B is a plan view of communication patterns on a front surface side of the commutator disk 100 transparently viewed from the rear surface side while omitting electrode patterns and an insulating substrate. FIG. 14C is a plan view showing a front surface side of the commutator disk.

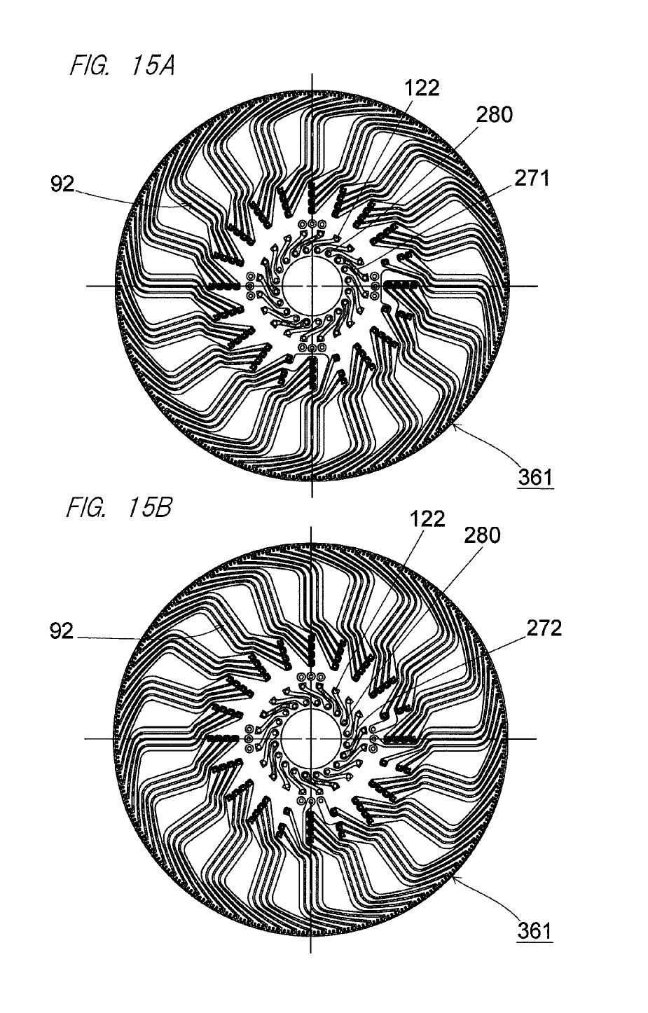

FIG. 15A is a plan view showing a coil pattern on a rear surface side of the first coil disk shown in FIG. 13, and FIG. 15B is a plan view of a coil pattern on a front surface side of the first coil disk transparently viewed from the rear surface side while omitting the coil patterns on the rear surface side and the insulating substrate.

The commutator disk 100 shown in FIG. 14 is similar to that shown in FIG. 7 except that an outer diameter thereof is further reduced as compared with that shown in FIG. 7.

As shown in FIG. 15A, in addition to the coil pattern 92, a plurality of rear-surface-side first communication patterns 271 are provided on a rear surface of the first coil disk 361. As shown in FIG. 15B, in addition to the coil pattern 92, a plurality of front-surface-side first communication patterns 272 are provided on a front surface side of the first coil disk 361. Interlayer connections between the electrode patterns 110, the rear-surface-side first communication patterns 271, and the front-surface-side first communication patterns 272 are achieved by inner through-holes 122 positioned radially inside. Interlayer connections between the rear-surface-side first communication patterns 271 and the front-surface-side first communication patterns 272 are achieved by relay through-holes 280. The rear-surface-side first communication patterns 271, the front-surface-side first communication patterns 272, and the relay through-holes 280 are similar to the rear-surface-side first communication patterns 251, the front-surface-side first communication patterns 252, and the relay through-holes 260 shown in FIG. 9 except that layers are formed on both surfaces of the first coil disk 361.

According to this embodiment, without providing the connection disk 200 in the rotor 82, the outer diameter of the commutator disk 100 can be reduced while the inner diameter of the commutator disk 100 is made equal to that of the commutator disk 835 of the comparative example. Thereby, the substrate area (difference between an inner diameter and an outer diameter) of the commutator disk 100 can be made small.

The present invention has been described above based on the embodiments, but it can be understood by the persons skilled in the art that various modifications can be made to respective constituent elements and respective processes of the embodiments within the scope of the claims. Modified embodiments will be described below.

One or all of coil disks and each of the commutator disk and the connection disk may be a single-sided substrate.

Even when the connection disk is provided, a layer on one surface or layers on both surfaces of one or plural coil disks may be utilized as a formation layer or formation layers for the communication patterns of respective segments.

When a layer on one surface of a coil disk or layers on both surfaces thereof are utilized as a formation layer or formation layers for the communication patterns, it is preferred that the uppermost coil disk (closest to the commutator disk) is utilized in view of electric resistance, but another coil disk may be utilized.

The shapes of the commutator disk, the connection disk, and the coil disks are not required to be disk-like strictly, but they are preferably considered as a circle when viewed from axial direction.

In addition to the above, the number of magnets and arrangement angle pitches thereof, the number of turns of coil pattern (the number of rows of coil pattern), the number of stacked coil disks and the stacking form thereof (angular shift amount between layers), the numbers of pin insertion holes and through-holes, the number of commutator segments, and other parameters can be set properly according to required performance and cost. Further, the number of turns of the coil pattern may be different in respective coil disks. Incidentally, when the coil pattern has one row, the respective terms “partial coil pattern group”, “inner communication pattern group”, “radial pattern group”, and “outer communication pattern group” in the description of the embodiments should be read so as not to include the word “group”, such as “partial coil pattern”, “inner communication pattern”, “radial pattern”, and “outer communication pattern”.

The electric power tool may include various electric tools having a rotational driving portion composed of the disk motor, such as a belt sander or a rotary band saw equipped with the disk motor in addition to the grass cutter shown in the embodiments.

What is claimed is:

1. A disk motor comprising:
a rotor having a commutator disk and at least one coil disk;
a stator having a magnetic flux generating portion facing a coil pattern of the coil disk;
a current supplying portion supplying current to the coil pattern via the commutator disk; and
an output shaft rotated by rotational force of the rotor,
wherein the commutator disk has a first layer provided with a plurality of electrode patterns constituting a plurality of commutator segments and arranged around the output shaft,
the plurality of electrode patterns include first-group electrode patterns and second-group electrode patterns,
first communication patterns mutually connecting the first-group electrode patterns between which a predetermined number of electrode patterns are sandwiched are provided to the respective first-group electrode patterns,
second communication patterns mutually connecting the second-group electrode patterns between which a predetermined number of electrode patterns are sandwiched are provided to the respective second-group electrode patterns, and
the first and second communication patterns are present on different layers, and a second layer on which at least one of the first and second communication patterns are present and a third layer on which at least the other of the first and second communication patterns are present are provided.

2. The disk motor according to claim 1, wherein at least either of the first and second communication patterns are separately present in a plurality of layers.

3. The disk motor according to claim 1, wherein the first and second communication patterns mutually connect two points different in both circumferential position and radial position at least on one layer.

4. The disk motor according to claim 1, wherein when serial numbers are attached to the plurality of electrode patterns around the output shaft, the first-group electrode patterns are odd-numbered electrode patterns, and the second-group electrode patterns are even-numbered electrode patterns.

5. The disk motor according to claim 1, wherein the first and second communication patterns are separately present in layers on both surfaces of the commutator disk and in a plurality of layers having the coil pattern formed thereon.

6. The disk motor according to claim 1, wherein the rotor is provided with a connection disk in addition to the commutator disk and the coil disk, and
the first and second communication patterns are separately present in layers on both surfaces of the commutator disk and layers on both surfaces of the connection disk.

7. The disk motor according to claim 5, further comprising relay conductor portions connecting the first communication patterns between different layers,
wherein the relay conductor portions are present at positions closer to the output shaft than the electrode patterns.

8. The disk motor according to claim 1, wherein the rotor is provided with a connection disk in addition to the commutator disk and the coil disk, and
the first communication patterns are present on the other surface of the commutator disk, and the second communication patterns are separately present in layers on both surfaces of the connection disk.

9. The disk motor according to claim 8, wherein the first and second communication patterns are arranged so that radial positions of the first and second communication patterns fall within a range of presence of the electrode patterns when viewed from a direction of the output shaft.

10. The disk motor according to claim 1, wherein the current supplying portion has brushes in contact with the plurality of electrode patterns.

11. An electric power tool equipped with the disk motor according to claim 1.
